(19) United States
(12) Patent Application Publication
(10) Pub. No.: US 2018/0297742 A1
(43) Pub. Date: Oct. 18, 2018

(54) DISPOSABLE CONTAINER FOR COMMERCIALIZING INDIVIDUAL FROZEN FOOD PORTIONS AND METHOD OF USING THE SAME

(71) Applicant: EVIVE SMOOTHIE INC., Montreal (CA)

(72) Inventors: Dominic DUBE, Montreal (CA); Philippe FONTAINE CASTONGUAY, Saint-Amable (CA)

(21) Appl. No.: 15/956,171

(22) Filed: Apr. 18, 2018

(30) Foreign Application Priority Data
Apr. 18, 2017 (CA) 2964569

(51) Int. Cl. B65D 1/36; B65D 1/24; B65D 43/02; B65D 81/18; B65D 51/32; B65D 85/72; A23L 19/00; A23L 2/02; A23L 2/42

(52) U.S. Cl. CPC B65D 1/36; B65D 1/24; B65D 43/0204; B65D 81/18; B65D 51/32; B65D 2543/00361; A23L 19/09; A23L 2/02; A23L 2/42; B65D 2543/00092; B65D 2543/00296; B65D 85/72

(57) ABSTRACT

A disposable container for commercializing individual frozen food portions is described. It is made of a plastic material and has a plurality of individual pockets defining each a volume configured for containing a portion of frozen food. Each pocket has a bottom wall and a lateral wall extending from the bottom wall and a top opening, the bottom wall having a thickness inferior to the thickness of the lateral wall. The portion of frozen food is extracted from its respective individual pocket by pushing in on the bottom wall of the pocket. A method for packaging, commercializing and using individual frozen food portions is also disclosed. The container and method are particularly useful for preparing a smoothie from frozen puree of vegetables and fruits. The container is particularly adapted for being shipped directly to the consumer. An insert and method for transforming a jar into a shaker are also disclosed.

### CROSS-REFERENCE TO RELATED APPLICATIONS

The present patent application claims the benefits of priority of Canadian Patent Application No. 2,964,569, entitled “Contenant Evive”, and filed at the Canadian Intellectual Property Office on Apr. 18, 2017, the content of which is incorporated herein by reference.

### FIELD OF THE INVENTION

The present invention belongs to the field of the food and beverage industry and generally relates to a disposable container for commercializing individual frozen food portions, such as but not limited to vegetable and fruit puree preparation for the making of smoothies. An insert and a method of using the same for transforming ajar into a shaker are also disclosed.

### BACKGROUND OF THE INVENTION

For many years now, frozen food has helped consumers reduce the time they spend preparing their meals. Frozen food will help preserve food safety, flavour, texture and colour if well packaged.

To improve convenience of food in homogeneous or heterogeneous puree texture like smoothies, soups, sauces, chili, that are frozen for conservation purpose, it can be portioned and sold in small frozen shapes. The consumer takes the amount of small frozen shapes needed for the meal and put the rest in the freezer. This adds a lot of convenience for the consumers.

The current packaging for such product is usually a bag or a box in which the small frozen shapes are in contact with one another. One drawbacks was identified with the use of such packaging for this type of food product. The small frozen shapes may melt partially during transit time if the product is bought online or at the grocery store. If the small frozen shape partially melts during transit time, melted or soften area of the frozen shapes are in contact with one another. When the temperature drops back to freezing point, all the small frozen shapes agglutinate together. It is then hard to break down afterward when needed.

This becomes problematic even more now that companies deliver or want to deliver this kind of product online. The delivery time and the outside temperature where the package transit if always different. One package may begin journey in a cold temperature city but end up its journey in a warm place 48 hours later. The result is that a number of products will arrive partially or completely melted and therefore, have lost its portioned advantage. Also, to ship frozen food is more expensive, complicated and sometime dangerous than shipping refrigerated food because more refrigerant and insulation must be used or dry ice. Dry ice poses a risk for health during transportation because of the emanation of carbonated gas. A good way to improve shipping cost of frozen goods is to be able to ship the goods refrigerated or at room temperature when possible and that they are frozen in the consumer home freezer.

Products like smoothies or soup in frozen shape sometimes require to add a portion of liquid for preparation. For example, smoothies or soup in frozen cubes require the addition of a portion of water or milk or other liquid for preparation. To prepare such products, consumer must add a portion of liquid and heat the small frozen portion to bring to desired temperature and consistency. Current options to prepare such products include microwave, stove, oven, adding boiling liquid, use a shaker or simply wait for the product to melt at higher ambient temperature. No options currently allow the consumer to efficiently transform the product in a consumable consistency by braking or sizing down the small frozen shapes back in a puree like texture without using any device and in a short period of time.

### SUMMARY OF THE INVENTION

The shortcomings of the prior art are generally mitigated by a disposable container for commercializing individual frozen food portions. The disposable container is made of a plastic material and comprises a plurality of individual pockets defining each a substantially identical volume configured for containing a substantially identical portion of frozen food. Each pocket has a bottom wall and at least one lateral wall extending from the bottom wall and a top opening. The bottom wall having a first thickness inferior to a second thickness of the at least one lateral wall, whereby in use, the portion of frozen food is extracted from its respective individual pocket by pushing in on the bottom wall of the pocket.

According to a preferred embodiment, each individual pocket defines a substantially triangular shape section located circumferentially at a predetermined distance from a centre of the container and at a regular interval from one another, each pocket having two lateral walls diverging from the center and a third semi-circular wall connecting the two lateral walls. Preferably, two adjacent diverging lateral walls of two adjacent pockets are fused to form a unique diverging lateral wall. The disposable container may comprise from 4 to 8 individual pockets.

According to a preferred embodiment, the disposable container comprises a circumferential perimeter track extending from the top opening of each individual pocket, the perimeter track being configured for affixing a removable protecting lid covering all the upper openings of the pockets for protecting the food portion disposed into the pockets, the protecting lid being configured to be removed before extracting the frozen food portions from the pockets. Preferably, the protecting lid is configured to be peeled off before extracting the portions of frozen food portions from the pockets. Also, the disposable container and the protecting lid affixed thereto may form a hermetic container configured for maintaining an inert gas inside the container for preserving the food portions from oxygen. Preferably, the inert gas is carbon dioxide or CO₂.

According to a preferred embodiment, the plastic material forming the disposable container comprises polyethylene terephthalate or PET.

According to a preferred embodiment, the frozen food is used for preparing a smoothie.

According to a second aspect, the invention is directed to a method for packaging, commercializing and using individual frozen food portions, the method comprising the steps of:
a. providing a disposable container made by moulding a sheet of a plastic material and comprising a plurality of individual pockets having each a bottom wall and at least one lateral wall extending from the bottom wall in order to form an top opening, the bottom wall having a first thickness inferior to a second thickness of the at least one lateral wall, each pocket defining a substantially identical volume configured for containing a substantially identical food portion;
b. filling each individual pocket with the substantially identical food portion;
c. freezing the food portions;
d. commercializing the disposable container; and
e. pushing in on the bottom wall of at least one of the pockets for extracting at least one portion of frozen food from the respective pocket;
wherein step c) of freezing the food portions is performed before or after step d) of commercializing the disposable container.

According to a preferred embodiment, the disposable container comprises a circumferential perimeter track extending from the upper openings of the individual pockets. The method may then further comprise the steps of:
after step b), affixing to the perimeter track a removable lid configured for covering all the upper openings of the pockets for protecting all the substantially identical food portions disposed into the pockets; and
before step e), removing the protecting lid.

According to a preferred embodiment, the protecting lid is peeled off to be removed. The lid may have preferably an handle on its edge to ease the removal of the lid.

According to a preferred embodiment, the disposable container and the protecting lid affixed thereto form a hermetic container configured for maintaining an inert gas inside the container for preserving the frozen food from oxygen, the method comprising before step d) the step of injecting the inert gas into the container.

According to a preferred embodiment, the method further comprises the step of letting melt or shaking at least one portion of frozen food once extracted from its respective pocket for preparing a smoothie.

According to a third aspect, the invention is directed to an insert for transforming a jar closable by a lid into a shaker for preparing a liquid food preparation from individual frozen food portions, the jar comprising an opening with a peripheral edge configured to be closed by the lid, the insert comprising:
a flat support configured to be non-permanently affixed adjacently to the jar's opening when the jar is closed with the lid; and
a plurality of breaking elements extending from one side of the support;
whereby, in use, the insert is maintained in place once the jar's opening is closed forming as such the shaker, the plurality of breaking elements extending inside the jar allowing breaking the individual frozen food portions introduced into the shaker when the shaker is shaken.

According to a preferred embodiment, the flat support of the insert is configured to fit in size with the opening of the jar in order to cover the opening and be supported by the peripheral edge of the opening, the flat support being maintained in place by the lid closing the jar.

According to another preferred embodiment, the lid is a metallic lid and the flat support has a first diameter inferior of a second diameter of the jar's opening, the flat support also comprising a magnet for non-permanently affixing the flat support to the metallic lid before closing the jar with the lid.

According to a preferred embodiment, the plurality of breaking elements is a plurality of breaking blades parallely extending from the support. Preferably, each blade has a size configured to fit with the support, the size of a first blade located on a center of the support or adjacent to the center of the support being larger than the size of a second blade being adjacent of the first blade and closer to an edge of the support.

According to a preferred embodiment, the insert may further comprise a reinforcing element located between two adjacent blades and in contact with the support for maintaining the blades into their parallel position.

According to a preferred embodiment, the insert is made by moulding a plastic material.

According to another aspect, the invention is also directed to method for the making of a liquid food preparation from individual frozen food portions, the method comprising the steps of:
a. inserting the individual frozen food portions into ajar with optionally an edible liquid, the jar comprising an opening with a peripheral edge and being configured to be closed by a lid;
b. providing an insert comprising:
   a flat support configured to be non-permanently affixed adjacently to the jar's opening when the jar is closed with the lid; and
   a plurality of breaking elements extending from one side of the support;
c. positioning the insert adjacently to the jar's opening with the plurality of breaking elements extending inside the jar;
d. closing the jar with the lid, the lid maintaining in place the insert; and
e. shaking the jar for breaking the individual frozen food portions introduced into the jar and obtaining a liquid food preparation from the individual frozen food portions and the optional edible liquid.

According to a preferred embodiment, the flat support is configured to fit in size with the opening of the jar in order to cover the opening and be supported by the peripheral edge of the opening, the method comprising the steps of: positioning the flat support on the peripheral edge of the jar's opening with the plurality of breaking elements extending inside the jar before closing the jar with the lid, the insert being maintained in place inside the closed jar by the lid closing the jar.

According to a preferred embodiment, the lid is a metallic lid and the flat support has a first diameter inferior of a second diameter of the jar's opening, the flat support also comprising a magnet facing the lid when the lid closes the jar, the method comprising the step of: non-permanently affixing the flat support to the metallic lid with the magnet before closing the jar with the lid.

According to a preferred embodiment, the individual frozen food portions comprises vegetable(s) and/or fruit(s), the liquid food preparation being then a smoothie.

Other and further aspects and advantages of the present invention will be better understood upon the reading of the illustrative embodiments about to be described or will be indicated in the appended claims, and various advantages not referred to herein will occur to one skilled in the art upon employment of the invention in practice.

### BRIEF DESCRIPTION OF THE DRAWINGS

The above and other aspects, features and advantages of the invention will become more readily apparent from the following description, reference being made to the accompanying drawings in which:

FIG. 1A is a top perspective view of a disposable container according to a preferred embodiment of the invention;

FIG. 1B is a bottom plan view of a disposable container according to a preferred embodiment of the invention;

FIG. 2 is a top perspective view of the disposable container with the lid according to a preferred embodiment of the invention;

FIG. 3 illustrates how the frozen food portions are pushed out the disposable container shown on FIGS. 1 and 2 according to a preferred embodiment of the invention;

FIG. 4 is a flowchart illustrating a method for packaging, commercializing and using individual frozen food portions according to preferred embodiments of the invention;

FIG. 5 is an exploded view of ajar, jar's lid and insert for transforming the jar closable by the lid into a shaker for preparing a liquid food preparation from individual frozen food portions according to a preferred embodiment of the invention;

FIG. 6 is a bottom perspective view of the insert and lid illustrated on FIG. 5 according to a preferred embodiment of the invention;

FIG. 7 shows the insert, jar and lid of FIG. 5 in a closed configuration according to a preferred embodiment of the invention;

FIG. 8 is an exploded view of a conventional jar with a jar's lid and an insert with a magnet for transforming the jar closable by the lid into a shaker for preparing a liquid food preparation from individual frozen food portions according to a preferred embodiment of the invention;

FIG. 9 is a top perspective view of the insert with the magnet illustrated on FIG. 8 according to a preferred embodiment of the invention;

FIG. 10 a bottom view of the insert with the magnet illustrated on FIGS. 8 and 9 according to a preferred embodiment of the invention; and

FIG. 11 is a flowchart illustrating for the making of a liquid food preparation from individual frozen food portions according to a preferred embodiment of the invention;

### DETAILED DESCRIPTION OF THE PREFERRED EMBODIMENT

A novel disposable container and insert will be described hereinafter. Although the invention is described in terms of specific illustrative embodiments, it is to be understood that the embodiments described herein are by way of example only and that the scope of the invention is not intended to be limited thereby.

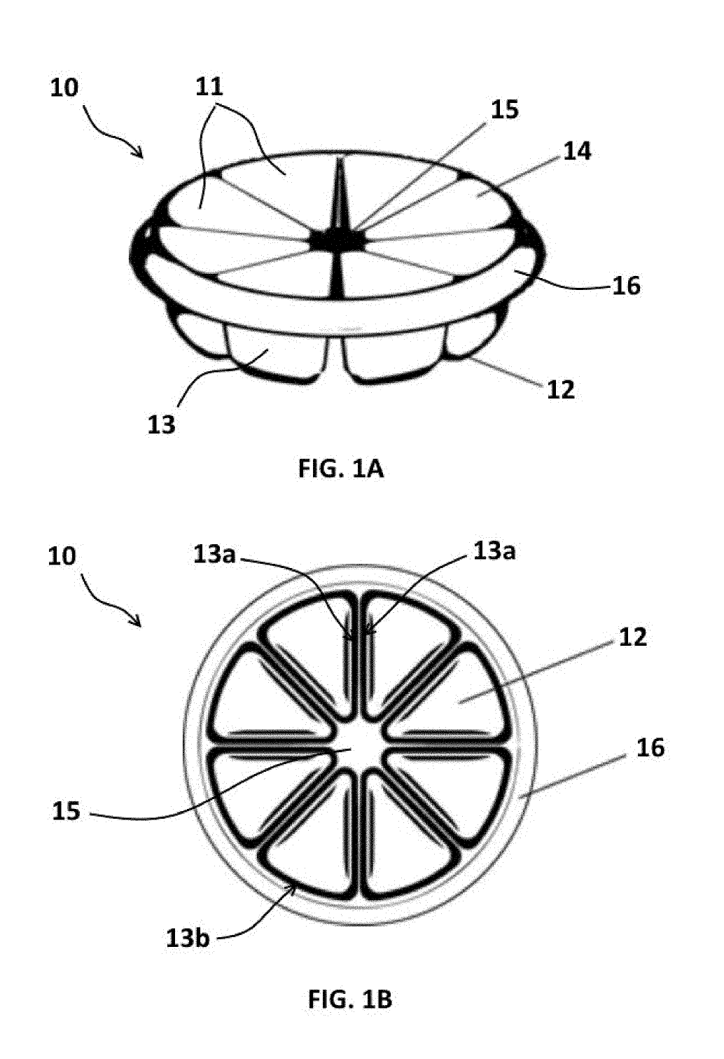

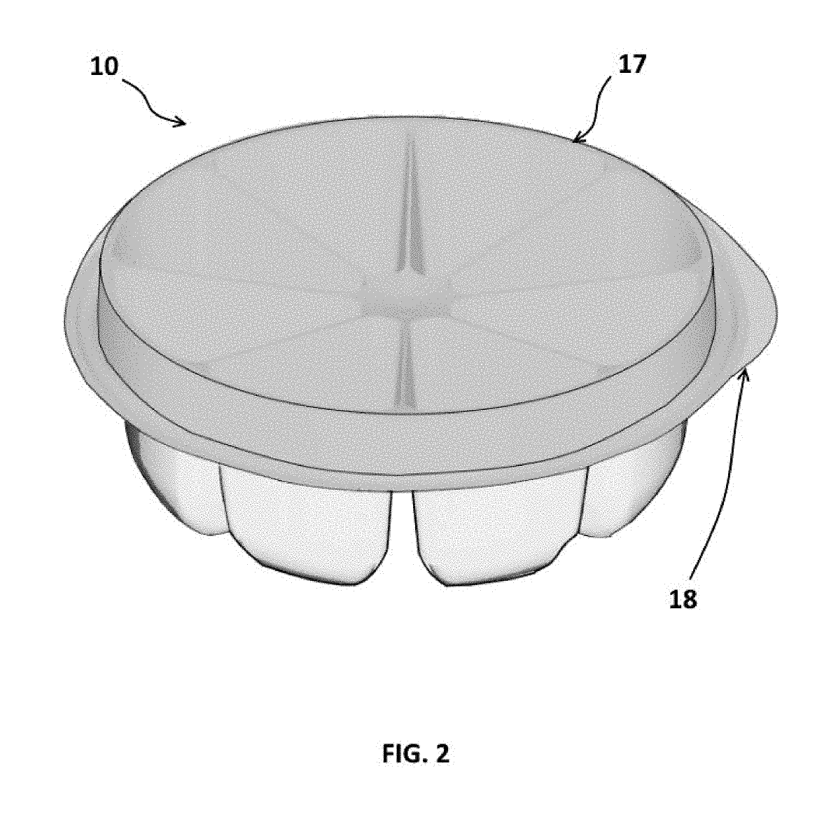

FIGS. 1 to 3 shows a disposable container (10) according to a preferred embodiment of the invention. The container (10) is used for commercializing individual frozen food portions (20). The disposable container is made of a plastic material, generally polyethylene terephthalate or PET. Other plastic materials known in the art as compatible with food may be used without departing from the scope of the present invention. By “disposable”, it is understood that the container cannot be reused. However, the plastic material can be recycled to be ecofriendly.

AS shown on FIGS. 1A and 1B, the container (10) comprises a plurality of individual pockets (11). Each pocket defines a substantially identical volume configured for containing a substantially identical portion of food (20). Each pocket has a bottom wall (12) and at least one lateral wall (13) extending from the bottom wall and a top opening (14). The bottom wall (12) has a first thickness inferior to a second thickness of the at least one lateral wall (13). To obtain this difference of thicknesses, the bottom wall is more stretched than the lateral wall(s) during the thermoforming of the container. The bottom thickness needs to be less than the side walls. This is obtained by using a plug assist in the thermoforming process. The plug assist needs to be precisely control to stretch the film to a precise distance from bottom. It was found that using the plug assist for half the container depth (about 0.45 in) and then using the thermoforming air pressure to form the rest of the forming enable the film to keep the side thickness while stretching the bottom of the container making it less thick than the walls. This creates a breach in the solidity of the bottom and makes it possible to push a bottom as you would do with a press button.

Example: The initial polymer film (PET) used for making the disposable container is between 10 and 15 mil (0.254-0.381 mm). Using the plug assist on about 0.5% of the depth, the plastic film is stretched at a rate of about 0.3 mil per inch. The thickness of the bottom wall is between 2 and 4 mil lower than the walls. If the initial film is 15 mil, the thickness of the walls will be between 14 and 15 mil and the bottom of the plate of about 13. If the film is 10 mil, the thickness of the walls is between 9 and 10 mil and the bottom is about 7 mil.

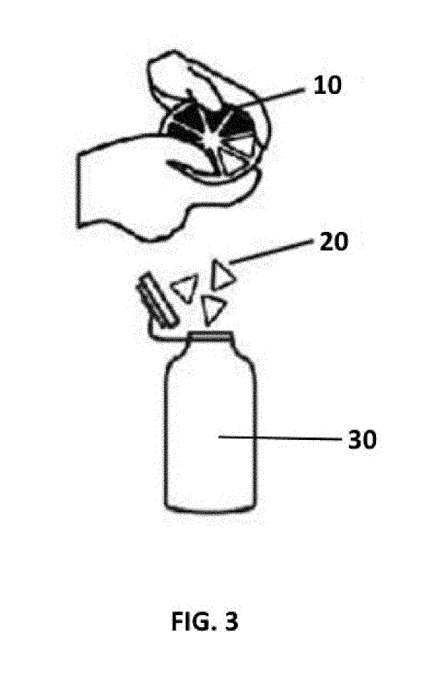

As shown on FIG. 3, the portion of frozen food (20) is extracted from its respective individual pocket (11) by pushing in on the bottom wall (12) of the pocket. The result is that each pocket or recess acts like a button from which the user can push the frozen food portion out (e.g. puree) without difficulties.

According to the preferred embodiment illustrated on FIGS. 1-3, each individual pocket (11) may defines a substantially triangular shape section located circumferentially at a predetermined distance from the centre (15) of the container defining a circular shape, and at a regular interval from one another. Each pocket has two lateral walls (13a) diverging from the center (15) and a third semi-circular wall (13b) connecting the two lateral walls (13a). Preferably, two adjacent diverging lateral walls of two adjacent pockets could be fused to form a unique diverging lateral wall (not shown). The disposable container may comprise from 4 to 8 individual pockets, more preferably 8 as illustrated.

The disposable container (1) also comprises a circumferential perimeter track (16) extending from the top opening (14) of each individual pocket (11). The perimeter track (16) is configured for affixing a removable protecting lid (17) covering all the upper openings of the pockets for protecting the food portion disposed into the pockets. The protecting lid is configured to be removed from the track (entirely or partially) before extracting one or more frozen food portions from the pockets. Preferably, the protecting lid is configured to be peeled off before extracting the portions of frozen food portions from the pockets. The lid may include a peripheral portion forming a handle (18) to ease its removal.

The disposable container (10) and the protecting lid (17) affixed thereto form a hermetic container configured for maintaining an inert gas inside the container for preserving the food portions from oxygen. Preferably, the inert gas is carbon dioxide or CO₂. Polyethylene terephthalate (PET) is particularly adapted for making the container and the lid in order to keep the gas inside the hermetic container.

According to a preferred embodiment, the frozen food is particularly useful for preparing a smoothie from frozen food portion of vegetable and/or fruit puree, in combination or not with an edible liquid (40) such as, but not limited to, water, broth, milks from animals (cow, goat, . . . ), soya milk, almond milk, or the like.

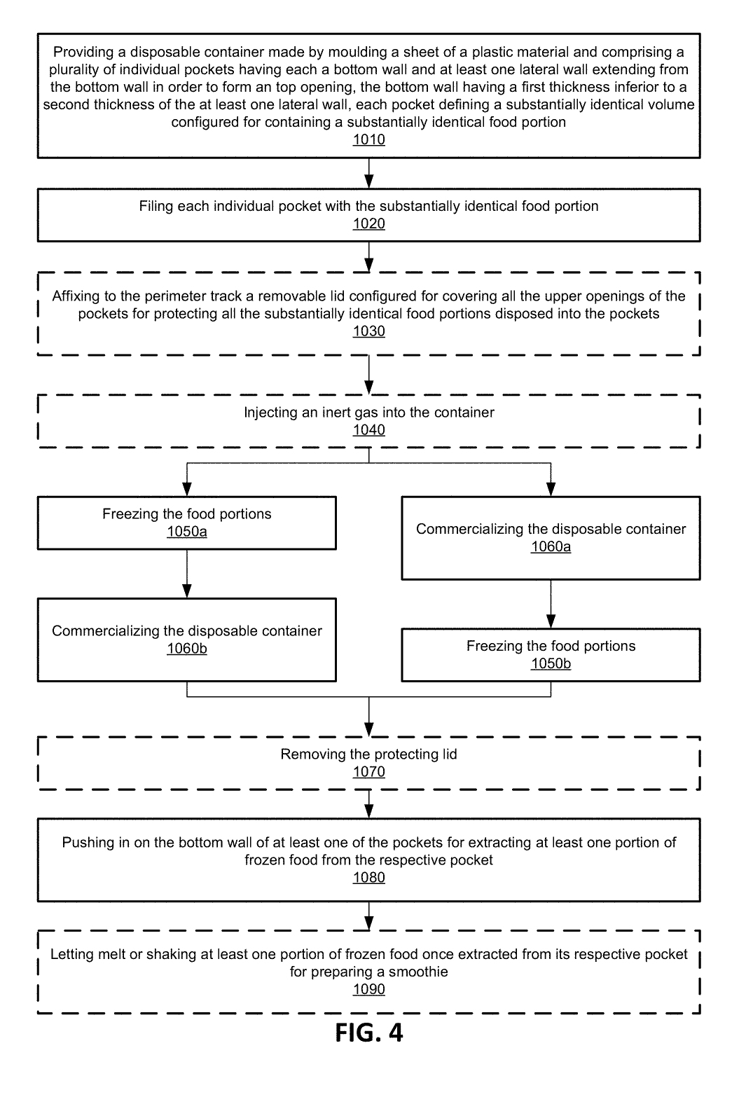

Therefore, the invention is also directed to a method for packaging, commercializing and using individual frozen food portions. As illustrated on FIG. 4, the method (1000) comprises the steps of:
a. providing a disposable container made by moulding a sheet of a plastic material and comprising a plurality of individual pockets having each a bottom wall and at least one lateral wall extending from the bottom wall in order to form an top opening, the bottom wall having a first thickness inferior to a second thickness of the at least one lateral wall, each pocket defining a substantially identical volume configured for containing a substantially identical food portion (1010);
b. filling each individual pocket with the substantially identical food portion (1020);
c. freezing the food portions (1050a or 1050b);
d. commercializing the disposable container (1060a or 1060b); and
e. pushing in on the bottom wall of at least one of the pockets for extracting at least one portion of frozen food from the respective pocket (1080).

As shown on FIG. 4, the step c) of freezing the food portions (1050a) may be performed before step d) of commercializing the disposable container (1060b). This means that the disposable container containing the food is prepared and commercialized frozen. Alternatively, the step c) of freezing the food portions (1050b) may be performed after step d) of commercializing the disposable container (1060a), meaning that the person purchasing the disposable container can freeze the container. In that last case, the container can be preferably pasteurized prior to be commercialized and ship at a low temperature of between 0 to 4 degrees Celsius or at room temperature depending of the ingredients and the manufacturing process allowing preservation.

As aforesaid, the disposable container (10) may comprises a circumferential perimeter track (16) extending from the upper openings (14) of the individual pockets (11). The method (1000) may then further comprise the steps of:
after step b), affixing to the perimeter track a removable lid configured for covering all the upper openings of the pockets for protecting all the substantially identical food portions disposed into the pockets (1030); and
before step e), removing the protecting lid (1070).

Advantageously, the protecting lid is glued or thermofused on the track in a way that it can be peeled off to be removed.

As aforesaid, the disposable container (10) and the protecting lid (17) affixed thereto may preferably form a hermetic container configured for maintaining an inert gas, such as CO₂, inside the container for preserving the frozen food from oxygen and extending its shelf life. Therefore, the method may also comprise before step d) the step of injecting the inert gas into the container (1040).

According to a preferred embodiment, the method may further comprise the step of letting melt or shaking at least one portion of frozen food once extracted from its respective pocket for preparing a smoothie (1090).

Advantageously, the disposal container provide a way to ship individual portions of food puree in one ergonomic and space efficient packaging to keep those portions intact and separated the frozen portions from one another at all times. It also allows, when possible, to ship frozen puree in individual shape in refrigerated or room temperature to reduce transportation cost and then it is frozen in the consumer home freezer to preserve it and use later use it. As shown on FIG. 3, the container by its structure allows easily pushing out the food portion directly into the jar (30) for preparing a liquid food preparation such as a smoothie. The present invention is not limited to the preparation of smoothie and may extended to the preparation of different food preparations such as puree for babies, sauce for rice or pasta or the like.

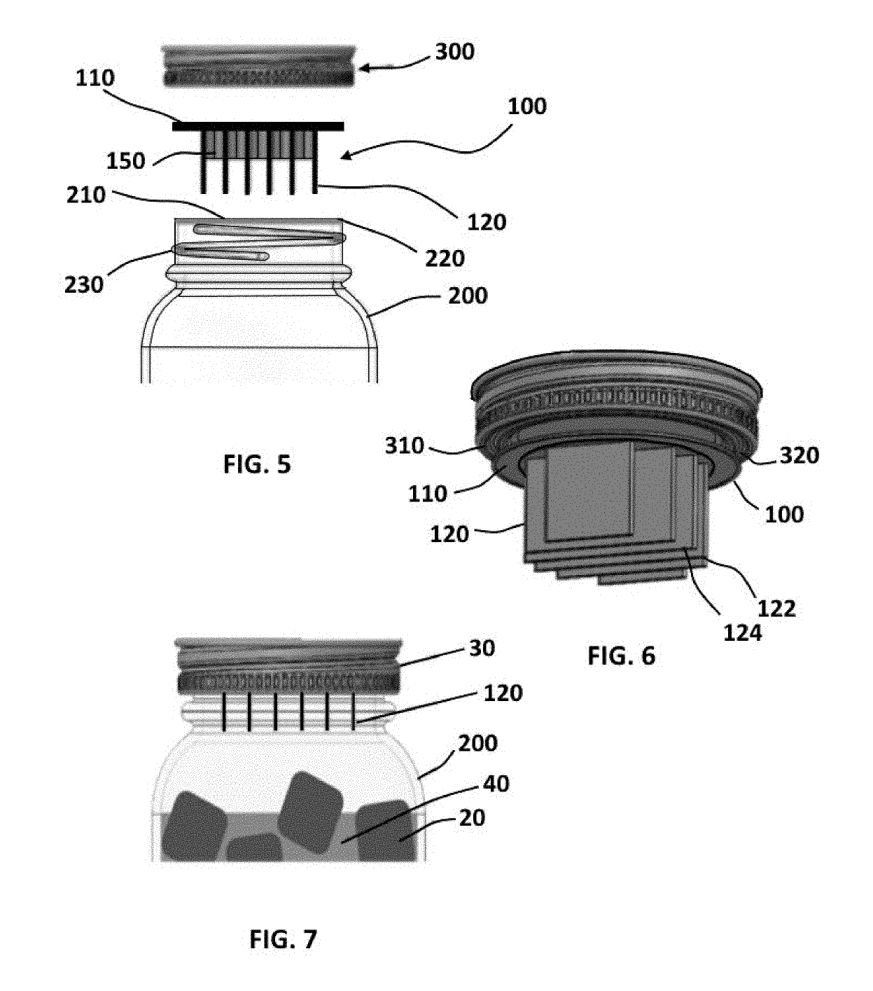

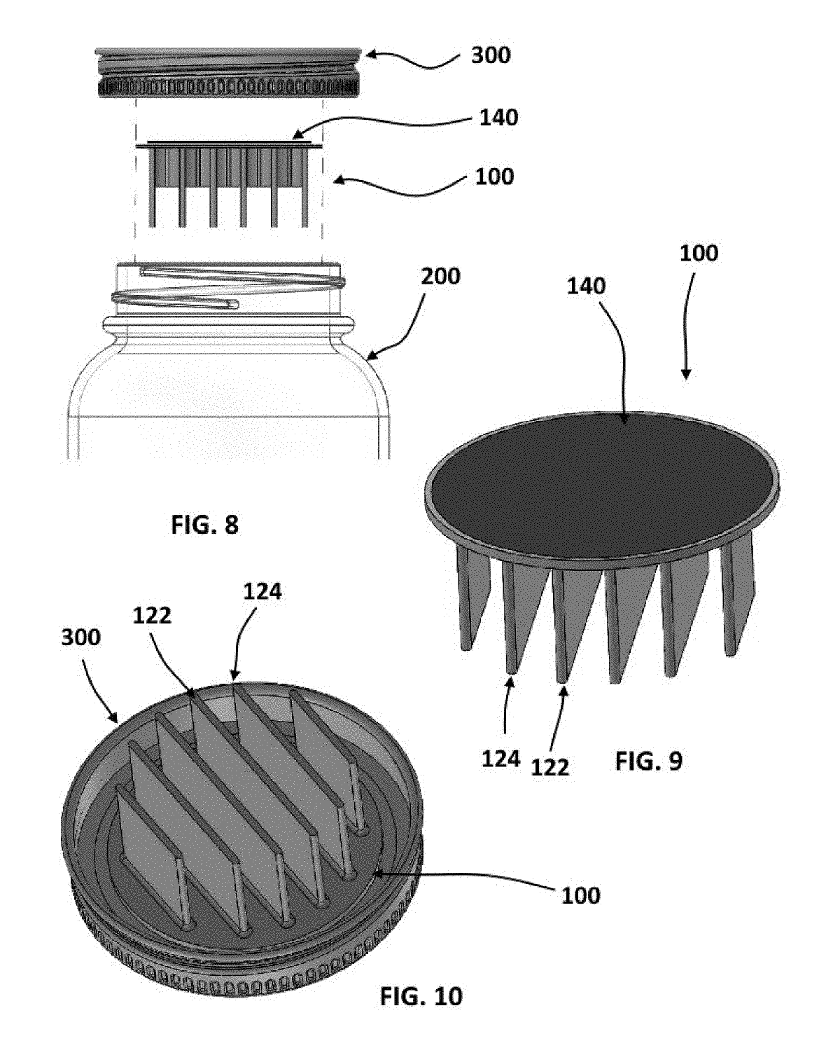

As illustrated on FIGS. 5 to 11, the invention is also directed to an insert (100) for transforming a jar (200) closable by a lid (300) into a shaker for preparing a liquid food preparation from individual frozen food portions.

A jar (200) typically comprising an opening (210) with a peripheral edge (220) configured to be closed by the lid (300), for instance by screwing or clapping. For example, the jar may be a mason jar. The jar's opening has a screw thread (230) on its outer perimeter to accept a metal ring (or “band”) (310). The band, when screwed down, presses a separate stamped tin-plated steel disc-shaped lid against the jar's rim. An integral rubber ring (320) on the underside of the lid creates a hermetic seal. The bands and lids usually come with new jars, but they are also sold separately. While the bands are reusable, the lids are intended for single use when canning.

According to the embodiment illustrated non FIGS. 5-7, the steel disc can be replaced by an insert (100) comprising a flat support (110) configured to fit in size with the opening of the jar (210) in order to cover the opening and be supported by the peripheral edge (220) of the opening. The insert (100) comprises a plurality of breaking elements (120) extending from one side of the flat support.

According to this embodiment, the support (110) is thus maintained in place on the edge of the jar's opening once the lid of the jar closes the jar's opening forming as such a shaker with the plurality of breaking elements (120) extending inside the jar allowing breaking the individual frozen food (20) portions introduced into the shaker when the shaker is shaken.

According to another embodiment illustrated on FIGS. 8-10, the insert comprising a plurality of breaking elements (120) can also be held in place by a magnetic bound with the metallic lid. In this option, the diameter of the insert is inferior of the jar's opening (see FIG. 10). A magnet (140) is permanently assembled on the flat side of the insert. Usually, a food grade glue is use to assemble the magnet and the insert. One may understand that other way of assembling the magnet and the insert are possible like clipping, overmolding, plastic welding. The magnet should generate a strong enough magnetic bound with the metallic lid to resist the action of shaking and breaking the individual frozen food (20) portions.

As illustrated on FIGS. 5-10, the breaking elements may be breaking blades parallely extending from the support. Preferably, as shown on FIG. 6, each blade has a size configured to fit with the support, the size of a first blade (122) located on or adjacent to the center of the support may be larger than the size of a second blade (124) being adjacent of the first blade and closer to the edge (130) of the support. Although a plurality of blades are presented here, one may understand that other configurations for the breaking elements can be considered without departing from the scope of the present invention, e.g. a plurality of sharp rods, knifes or the like.

As shown on FIG. 5 or 10, the insert may further comprise a reinforcing element (150) located between two adjacent blades and in contact with the support for maintaining the blades into their parallel position. The reinforcing element may avoid the blades from bending or breaking.

According to a preferred embodiment, the insert is made by moulding of a plastic material. Of course, the insert could also be made of a metallic material, coated or not, adapted to be in contact with food.

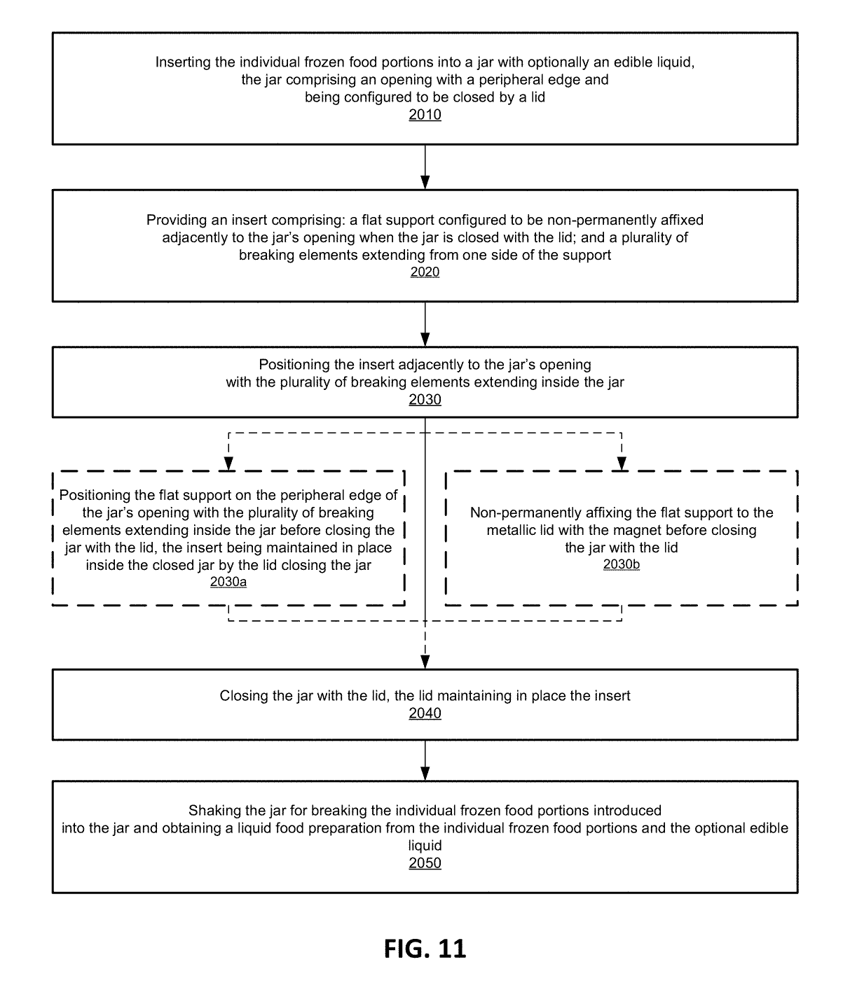

According to another aspect, the invention is also directed to a method (2000) for the making of a liquid food preparation from individual frozen food portions. As illustrated on FIG. 11, the method (2000) comprising the steps of:
a. inserting the individual frozen food portions into ajar with optionally an edible liquid, the jar comprising an opening with a peripheral edge and being configured to be closed by a lid (2010);
b. providing an insert comprising:
   a flat support configured to be non-permanently affixed adjacently to the jar's opening when the jar is closed with the lid; and
   a plurality of breaking elements extending from one side of the support (2020);
c. positioning the insert adjacently to the jar's opening with the plurality of breaking elements extending inside the jar (2030);
d. closing the jar with the lid, the lid maintaining in place the insert (2040); and
e. shaking the jar for breaking the individual frozen food portions introduced into the jar and obtaining a liquid food preparation from the individual frozen food portions and the optional edible liquid (2050).

In function of the type of jar used (Mason or conventional jar), the insert can be maintained in place inside the jar differently.

With a Mason jar, the flat support may configured to fit in size with the jar's opening in order to cover the opening and be supported by the peripheral edge of the opening. Then, the method comprising the steps of positioning the flat support on the peripheral edge of the jar's opening with the plurality of breaking elements extending inside the jar before closing the jar with the lid, the insert being maintained in place inside the closed jar by the lid closing the jar (2030a).

Alternatively, with a conventional jar (the lid being a one-piece metallic lid), the flat support typically has a first diameter inferior of a second diameter of the jar's opening. The flat side of the insert free of breaking element can be inserted inside the lid. To maintain the insert in place, the side of the flat support free of breaking elements comprises a fixing element comprising a magnet for interacting with the lid when the lid closes the jar. The method then also comprises the step of: non-permanently affixing the flat support to the metallic lid with the magnet before closing the jar with the lid. That way, the insert can be used with all conventional jar having a metallic lid (2030b).

The individual frozen food portions typically comprises vegetable(s) and/or fruit(s), the liquid food preparation being then a smoothie. As aforesaid, other sorts of preparation can be made using the same method (2000). Edible liquids typically comprises water, broth, animal milk (cow, goat, or the like), vegetal milk (soya, almond or the like), etc.

The insert as described herein allows people at home to transfer a conventional jar or a Mason jar into a shaker for frozen smoothies or soup small shape. It adds a lot of convenience because no heating device is require to reduce the particle size of the frozen shape. Mechanical energy is provided by the consumer by shaking and a piece of plastic is inserted in the jar to allow efficient braking of the frozen shape.

While illustrative and presently preferred embodiments of the invention have been described in detail hereinabove, it is to be understood that the inventive concepts may be otherwise variously embodied and employed and that the appended claims are intended to be construed to include such variations except insofar as limited by the prior art.

1. A disposable container for commercializing individual frozen food portions, the disposable container being made of a plastic material and comprising a plurality of individual pockets defining each a substantially identical volume configured for containing a substantially identical portion of frozen food, each pocket having a bottom wall and at least one lateral wall extending from the bottom wall and a top opening, the bottom wall having a first thickness inferior to a second thickness of the at least one lateral wall, whereby in use, the portion of frozen food is extracted from its respective individual pocket by pushing in on the bottom wall of the pocket.

2. The disposable container of claim 1, wherein each individual pocket defines a substantially triangular shape section located circumferentially at a predetermined distance from a centre of the container and at a regular interval from one another, each pocket having two lateral walls diverging from the center and a third semi-circular wall connecting the two lateral walls.

3. The disposable container of claim 2, wherein two adjacent diverging lateral walls of two adjacent pockets are fused to form a unique diverging lateral wall.

4. The disposable container of claim 2, comprising from 4 to 8 individual pockets.

5. The disposable container of claim 2, comprising a circumferential perimeter track extending from the top opening of each individual pocket, the perimeter track being configured for affixing a removable protecting lid covering all the upper openings of the pockets for protecting the food portion disposed into the pockets, the protecting lid being configured to be removed before extracting the frozen food portions from the pockets.

6. The disposable container of claim 5, wherein the protecting lid is configured to be peeled off before extracting the portions of frozen food portions from the pockets.

7. The disposable container of claim 5, wherein the disposable container and the protecting lid affixed thereto form a hermetic container configured for maintaining an inert gas inside the container for preserving the food portions from oxygen.

8. The disposable container of claim 7, wherein the inert gas is carbon dioxide or CO₂.

9. The disposable container of claim 1, wherein the plastic material forming the disposable container comprises polyethylene terephthalate or PET.

10. The disposable container of claim 1, wherein the frozen food is used for preparing a smoothie.

11. A method for packaging, commercializing and using individual frozen food portions, the method comprising the steps of:
a. providing a disposable container made by moulding a sheet of a plastic material and comprising a plurality of individual pockets having each a bottom wall and at least one lateral wall extending from the bottom wall in order to form an top opening, the bottom wall having a first thickness inferior to a second thickness of the at least one lateral wall, each pocket defining a substantially identical volume configured for containing a substantially identical food portion;
b. filling each individual pocket with the substantially identical food portion;
c. freezing the food portions;
d. commercializing the disposable container; and
e. pushing in on the bottom wall of at least one of the pockets for extracting at least one portion of frozen food from the respective pocket;
wherein step c) of freezing the food portions is performed before or after step d) of commercializing the disposable container.

12. The method of claim 11, wherein the disposable container comprises a circumferential perimeter track extending from the upper openings of the individual pockets, the method further comprising the steps of:
after step b), affixing to the perimeter track a removable lid configured for covering all the upper openings of the pockets for protecting all the substantially identical food portions disposed into the pockets; and
before step e), removing the protecting lid.

13. The method of claim 12, wherein the protecting lid is peeled off to be removed.

14. The method of claim 12, wherein the disposable container and the protecting lid affixed thereto form a hermetic container configured for maintaining an inert gas inside the container for preserving the frozen food from oxygen, the method comprising before step d) the step of injecting the inert gas into the container.

15. The method of claim 11, further comprising the step of letting melt or shaking at least one portion of frozen food once extracted from its respective pocket for preparing a smoothie.

16. An insert for transforming a jar closable by a lid into a shaker for preparing a liquid food preparation from individual frozen food portions, the jar comprising an opening with a peripheral edge configured to be closed by the lid, the insert comprising:
a flat support configured to be non-permanently affixed adjacently to the jar's opening when the jar is closed with the lid; and
a plurality of breaking elements extending inwardly from one side of the support;
whereby, in use, the insert is maintained in place when the jar's opening is closed forming as such the shaker, the plurality of breaking elements extending inside the jar allowing breaking the individual frozen food portions introduced into the shaker when the shaker is shaken.

17. The insert of claim 16, wherein the flat support is configured to fit in size with the opening of the jar in order to cover the opening and be supported by the peripheral edge of the opening, the flat support being maintained in place by the lid closing the jar.

18. The insert of claim 16, wherein the lid is a metallic lid and the flat support has a first diameter inferior of a second diameter of the jar's opening, the flat support also comprising a magnet for non-permanently affixing the flat support to the metallic lid before closing the jar with the lid.

19. The insert of claim 16, wherein the plurality of breaking elements is a plurality of breaking blades parallely extending from the support.

20. The insert of claim 19, wherein each blade has a size configured to fit with the support, the size of a first blade located on a center of the support or adjacent to the center of the support being larger than the size of a second blade being adjacent of the first blade and closer to an edge of the support.
